(19) United States
(12) Patent Application Publication
(10) Pub. No.: US 2007/0201982 A1
(43) Pub. Date: Aug. 30, 2007

(54) VENTILATOR AND VENTILATOR BLADE

(75) Inventor: Ralf Neumeier, Waldenburg (DE)

Correspondence Address: FROST BROWN TODD, LLC, 2200 PNC CENTER, 201 E. FIFTH STREET, CINCINNATI, OH, 45202, US

(73) Assignee: Ziehl-Abegg AG, Kunzelsau (DE)

(21) Appl. No.: 11/614,598

(22) Filed: Dec. 21, 2006

(30) Foreign Application Priority Data
Feb. 24, 2006 (EP) EP06003819.7
Dec. 22, 2005 (EP) EP05028264.9

(51) Int. Cl. B64C 11/28

(52) U.S. Cl. 416/142

(57) ABSTRACT

The invention provides a ventilator blade (1) with a loading edge (2) curved in the shape of an S in the blade sheet plane; and an outside edge (4) that is shorter than the leading edge, in which the center of the outside edge (4) lies in the vicinity of the rotation axis (x) of the ventilator blade (1), as well as a ventilator (9) that uses at least one ventilator blade (1) according to the invention.

The invention concerns a ventilator and a ventilator blade.

In modern ventilators or fan wheels, ventilator blades which are shaped favorably for fluid mechanics, make possible a high efficiency, for example, with regard to the attained direct flow volume or the outflow pressure. A strong generation of noise, however, in the operation of the ventilator is frequently problematic.

For the reduction of the running noise, DE 199 480 75 uses an axial ventilator with blades that have an S-shaped leading blade edge with a protruding outer corner.

EP 887 558 B1 proposes ventilator blades with an S-shaped leading edge and a trailing edge which is a reflection of the leading edge.

U.S. Pat. No. 3,416,725 shows a blade shape with a double crescent-shaped leading edge and a single slightly crescent-shaped trailing edge.

DE 103 26 637 B3 describes a fan with an alternating rotary direction, which has blades with an S-shaped leading edge that greatly recedes toward the outside.

WO 1998005868 discloses a numerical method for the aeroacoustic optimization of an axial fan or its blade configuration.

U.S. Pat. No. 2,649,921 makes available a fan with very short and wide blades and triple-curved leading and trailing edges.

FR 27 280 28 describes blades with convex edge areas with large winglets.

Finally, U.S. Pat. No. 5,533,865 discloses a rotor for a windmill whose blades have a sawtooth-shaped rear edge.

Against this technical background, the invention deals with the problem of preparing a ventilator or ventilator blade which operates with low noise.

The invention solves this problem with a ventilator or a ventilator blade in accordance with the independent claims. The dependent claims contain advantageous developments.

Before the invention is described in more detail, a few terms will be explained to facilitate understanding. To this end, one can consider a ventilator with, for the most part, several star-shaped ventilator blades arranged on a hub by means of fixing devices (a ventilator in accordance with the invention uses ventilator blades in accordance with the invention, as they are described below) to move a substance surrounding the ventilator, such as air or also another gas or a liquid. The hub forms the center of the ventilator.

For each ventilator blade, a radial ray is defined, which runs outwardly in a straight line from the center of the hub through the middle of the individual blade foot of the ventilator blade.

Each ventilator blade has a leading edge that leads in the normal direction of movement when in operation, and a trailing edge that trails in the normal direction of movement when in operation. Preferably, an operation of the described device in the opposite running direction is also possible. Nevertheless, the leading and trailing edges are mostly optimally designed for only one running direction; the operation in the opposite direction cannot deliver optimal performance.

In the described ventilator, the “inside” is the hub; the “outside” is the housing or the shaft (if present, which is mostly the housing, however). The outside edge of the ventilator blade is, accordingly, the edge which is furthest from the hub; it is often shorter than the leading and trailing edges.

Furthermore, the ventilator blade sheet has a suction side, which suctions the inflowing air, etc., when in operation, and an opposite pressure side, where the pressure to expel the air, etc. builds up.

A ventilator in accordance with the invention is characterized, in contrast to a comparable conventional ventilator, by a reduced-noise operation. As already mentioned above, a ventilator in accordance with the invention employs at least one ventilator blade in accordance with the invention which is arranged around a hub (in the case of several ventilator blades, preferably at equal intervals). To affix the at least one blade, the ventilator comprises corresponding fixing devices; for example, a device on the hub holds a counterpiece fastened on the blade. Of course, the ventilator has a controllable motor, which provides for its operation—that is, the rotation of the at least one ventilator blade about an axis, conceived through the center of the hub. For the most part, the ventilator is located in a shaft or housing. The specialist knows of other details regarding the structure and the function of the conventional components of a ventilator, such as the drive or control; for that reason, a more detailed discussion need not be given here.

The at least one ventilator blade in accordance with the invention used by a ventilator in accordance with the invention generates noise when in operation, which is reduced, in comparison to comparable conventional ventilators, due to a special edge shape. The leading edge of a blade in accordance with the invention in the blade sheet plane is designed in the shape of an S—that is, it has two arcs with a reversal point. The reversal point is preferably located approximately in the middle of the leading edge; the arc laid outside, extending from the reversal point, preferably curves in a concave manner into the blade area--that is, in the direction of the radial ray, whereas the arc laid inside, extending from the reversal point, preferably curves in a convex manner away from the radial ray. The expression “in the blade sheet plane” is meant to clarify merely that the S-shape of the leading edge produces a bulge into the blade area or outwards from it and not, for example, a curvature perpendicular to it. However, it should be noted that in most developments, the individual points of the blade sheet do not line up on a plane in a geometrical sense; the individual points of the leading edge are mostly not located on a straight line either. In this respect, from a strict geometric perspective, a “blade sheet plane” very rarely exists.

The described S-shape of the leading edge leads to a reduced generation of noise when the ventilator is in operation, because the individual points of the leading edge strike a wave front (caused, for example, by a disturbance) at different times, which meets them, for example, in their direction of movement. For this reason, many (weak) acoustic waves arise successively on the wave front within a certain time period due to the time-staggered meeting of the individual points of the leading edge, whereas with noncurved ventilator blades, the more or less simultaneous meeting of all points of the leading edge on the wave front causes a single (strong) acoustic wave. Accordingly, in contrast to noncurved ventilator blades, which produce a short, high noise peak in a narrow frequency band, a partial, somewhat longer-lasting, but broad-band, less perceptible noise of lesser amplitude is produced with ventilator blades in accordance with the invention.

However, a ventilator in accordance with the invention avoids certain limitations which can appear due to a curved edge shape of the ventilator blades.

Namely, with ventilators, the attempt is made to minimize the air flow from the pressure side to the suction side of the ventilator blades via their outside edges. To this end, only the narrowest possible gap is often provided between the outside edge of a ventilator blade and the housing. On the other hand, the possibility should remain guaranteed for the adaptation of the blade angle of incidence (angle between the inflowing air and the chord, wherein the chord is the conceived straight line between the stagnation point on the front end of the blade, where the air flows divide, and its rear point) of the ventilator blade to external conditions or the user's wishes—that is, the rotation of the ventilator blade around the radial ray as a rotation axis. The adaptation mostly takes place before the starting of the ventilator, when the performance profile of the unit is coordinated with the special application. Alternatively, the ventilator is equipped with a control unit and sensors or an operator display and actuators. Then, the control unit can constantly establish an optimal angle of incidence with the aid of the actuators, for example, as a function of the sensor signals or operator inputs.

The narrower the gap is between the outside edge of the blade and the housing or the shaft which is selected, the smaller the adjustable blade adjustment range will be, in which the blade is not stopped by the housing wall. Here, a compromise in the gap width must be found, which does not involve excessively large disadvantages in terms of fluid mechanics, but which, nevertheless, permits a minimum rotation area for the angle of incidence of the ventilator blade.

With the known blade shapes with an S-shaped leading edge, however, there is no adjustability of the angle of incidence because of geometric reasons.

Costly fluid-mechanical investigations have shown that the adjustability of the angle of incidence with ventilator blades with an S-shaped leading edge, in which the center of the outside edge of the blades is in the vicinity of the rotation axis or the radial ray and in the ideal case, on the radial ray, remain guaranteed. The outside-edge intersection point of two lines running on the outside edge is, for example, designated as the “center.” One of these lines is defined as running from the front leading end of the outside edge (that is, where the leading edge and the outside edge meet) to the rear trailing edge (on which the outside edge and the trailing edge meet) and thereby at each point keeps the same distance to one long side edge of the outside edge (on which the suction side or the pressure side of the blade sheet and the outside edge meet) as it does to the other long side edge. The other line is defined as connecting the center of the long side edges of the outside edge with one another and thereby also running at every point in the center between the leading and trailing ends. The maximum permissible distance of the center from the radial ray thereby depends, in particular, on the rotation range of the angle of incidence to be attained and the tolerable gap width between the outside edge and the inside wall of the housing. Mostly, a smaller distance to the center is permissible in the longitudinal direction of the outside edge than in the direction perpendicular to it. Ideally, the intersection point of the radial ray with the outside edge is as close as possible to the center.

Since the center of the outside edge is in the vicinity of the radial ray, the angle of incidence of the ventilator blade remains, with the same gap width, equally broadly adjustable as with a corresponding noncurved blade; a ventilator, in accordance with the invention, therefore combines the advantage of noise reduction with the advantage of variable adjustability.

Some developments of the ventilator blade attain an additional noise reduction by an at least partially fringed trailing edge. A fraction of the noise emission in the ventilator operation which cannot be neglected regularly arises, namely, due to an interaction of the trailing edge with a turbulent boundary layer, which forms on the surface of the blade: for example, the trailing edge scatters and bends the flow which sweeps over it, which produces sound. Above all, in the nonoptimal operating area of the ventilator, the fringes of the trailing edge break up the vortex sweeping over the trailing edge, as it were, and thus provide for a clear noise reduction. In experiments, for example, the generation of noise, lower by as much as 3 dB, was measured for a blade with a fringed trailing edge, in comparison with a blade which was identical to the first blade except for the shape of the trailing edge.

Depending on the development, the fringe shape of the trailing edge has between two and several dozen to several hundred fringes. Preferably, the fringes are designed in the shape of teeth and comprise two edges, which converge to form a tip. In a particularly advantageous development, the edge lying inside is approximately perpendicular to the radial ray. Alternatively, the edge lying inside deviates from the perpendicular--for example, relative to the perpendicular, it falls on the radial ray toward the inside. In other embodiments, the edge lying outside is perpendicular to the radial ray or relative to the perpendicular, falls to the outside. Preferably, the two edges enclose an angle between 10° and 80°. Mostly, the tip formed by the edges is rounded off. In some developments, the fringes have an ellipsoidal, circular, or sinusoidal contour.

In one development, the individual fringes of the trailing edge are designed differently. For example, the tips which lie inside point slightly inwards, whereas the tips located further outside point in a direction perpendicular to the radial ray or are directed outwards.

In one embodiment, the size of the individual fringes depends on the inflow rate of the fluid and or a limit frequency to be specified, above which the diminishing of the noise is to be attained. The inflow rate for individual points on the trailing edge of the ventilator blade is calculated, among other things, with the aid of their distance to the hub and the rotation speed of the ventilator or determined with the aid of measurements with comparable blades (with or without the fringed trailing edge). Since the inflow rate for points lying on the trailing edge increases toward the outside, the fringes are also larger toward the outside. For this development, particularly good results can be demonstrated in experiments. In some developments, an inflow rate is determined for the site of each individual fringe—for example, by ascertaining the average of several inflow rates determined for different points of a fringe. Alternatively, only one average inflow rate is determined for several or all teeth. Moreover, the dependence of the fringe size on the inflow rate can be different for each individual fringe or groups of fringes. Fringes of the same fringe group can also have the same fringe size, whereby fringe groups lying next to one another then have clearly different fringe sizes. Other embodiments comprise fringes whose size does not depend on the inflow rate and/or the limit frequency. For example, shorter and longer fringes alternate along the trailing edge.

For the following description, a trailing edge without a fringe shape is defined. In some developments, the fringes are more or less set on this trailing edge without a fringe shape or protrude at least beyond it and thus widen the blade; with other developments, the fringes of the width of the blade add nothing, but rather, in comparison to the blade without the fringe shape, blade material is removed for the formation of the fringes. In this case, the trailing edge without the fringe shape defines the position of the tips. Often, a section of the trailing edge near the inside and/or outside edge is not fringed either. The outside and inside edges are not shortened, therefore, in comparison with the blade without the fringe shape. Other developments do not have any such sections and can thus shorten the outside and/or inside edge, under certain circumstances. Furthermore, developments exist with nonfringed sections in the center or on other sites of the trailing edge.

In order to simplify the manufacturing, one of the transitions of the fringe edges to the pressure and to the suction sides is rounded off, and the other one has a sharp edge in one development of the ventilator blade.

In the following developments, the trailing edge with or without fringes is favorably adapted, for fluid mechanics, to the S-shaped leading edge and the fixed position of the outside edge. Preferably, the trailing edge thereby also forms at least one arc in the “blade sheet plane”—in most developments, however, two or three arcs, wherein frequently only one arc is curved in a similarly strong manner as is the case with the leading edge. Mostly, the strongly shaped arc lies in the external third of the trailing edge and has a curvature which is parallel to the external arc of the leading edge. In the inside half of the trailing edge, for example, there are two flat arcs with a reversal point. The second arc becomes very flat and with another reversal point goes over into the external arc, parallel to the leading edge. Preferably, the widest site of the ventilator blade—that is, the point on which the leading and trailing edges lie the furthest from one another—lies in its inside fifth. However, it is also possible that the innermost point of the leading and the trailing edges marks the widest location. In most developments, the outside edge is the narrowest location of the blade.

The S-shape of the leading edge, in accordance with the invention, influences the flow in the ventilator operation: for example, the radial speeds and thus the distribution of the blade load change along the radius, and so forth. In order to balance this as much as possible, one development provides for a special structure of the ventilator blade, in which the ventilator blade sheet has a longitudinal curvature along the radial ray. Preferably, the blade thus has a convex curvature on its suction side and a concave curvature on its pressure side. For the most part, this longitudinal curvature is pronounced in a particularly strong manner in the outer half of the blade. In addition, another transverse curvature is mostly present over the width of the blade, so that the individual points of the inside and outside edges (viewed from the inside or outside) do not lie on a straight line either. For example, the blade area in the vicinity of the leading edge is transversely curved over its entire length away from the suctioned air, so that the inside and outside edges also have such a transverse curvature in the direction of their inflow end. The transverse curvature can have different magnitudes along the blade. Such a complex shape of the ventilator blade has proved itself as being favorable with respect to fluid mechanics and prevents or reduces a decline in performance caused by the crescent shape, which could otherwise arise under certain circumstances with more or less straight edges, in comparison with conventional blades. Rather, the same inflow, outflow, and circulating flow conditions can be produced for such a blade as is the case for a comparable conventional blade.

With most developments of the blade, the outside edge is preferably adapted to the shape of the mostly round shaft or housing around the ventilator (if it is then located in such a structure), in that it has approximately the same curvature as the inside wall of the housing. If one views the outside edge from the outside, in the direction of the radial ray, it mostly has a “blade shape”: its front end, which strikes the leading edge, and its rear end, which strikes the trailing edge, preferably have a rounded shape between the suction and the pressure sides, whereby the radius of the rounding is larger in the front leading end than is the case with the rear trailing end. From the leading end, in the direction of the trailing end, the outside edge width in the area of the first third of the outside edge initially increases and then declines more slowly. In most embodiments, the increase of the outside edge width is mainly attained by the curvature of a long side edge of the outside edge (and this side edge mostly meets with the suction side of the ventilator blade). This blade shape with a convex curvature augments the speed difference between the suction and the pressure sides and the extent of the air deflection. Also, the profiles of sections of the blade parallel to the outside edge have a blade shape.

In one embodiment, a transverse piece or winglet is placed over the entire length of the outside edge or even projecting over it. Such a transverse piece helps in reducing or keeping away air vortices, which frequently form on the end of the blade. Preferably, it protrudes toward both sides, perpendicular to the radial ray, wherein the two angles differ considerably from 90°, relative to the blade surface, as a function of their curvature along the radial ray, but together add up to approximately 180°. Another embodiment provides for a transverse piece that is inclined toward the outside and opposes the suctioned air.

For example, viewed from the outside, the transverse piece doubles or triples the width of the outside edge. The transverse piece protrudes equally far beyond the width of the outside edge, mostly in both directions. In one embodiment, the width changes from one corner point of the outside edge to the other, wherein up to the center of the outside edge, there is an increase of the width, and subsequently a decrease. Accordingly the smallest width of the transverse piece is on the ends of the outside edge; mostly, however, the width exceeds the width of the outside edge. Another embodiment does not provide for an exceeding of the width of the outside edge on its ends. Alternatively, there is a constant width over the length of the outside edge, or a constant width with a slowly decreasing conclusion to the ends. The variants with decreasing width of the transverse piece to the ends of the outside edge prove to be especially favorable for the permissible adjustment range of the angle of incidence.

In length, a ventilator blade measures, for example, 1.5 to 4 times its maximum width. The width varies considerably in some embodiments; for example, the width differs, at various points of the blade, by a factor of 2. The absolute blade size is scaled as a function of the desired blade volume.

The invention will be explained in more detail with the aid of embodiments, in addition to the appended drawings. The figures in the drawings show the following:

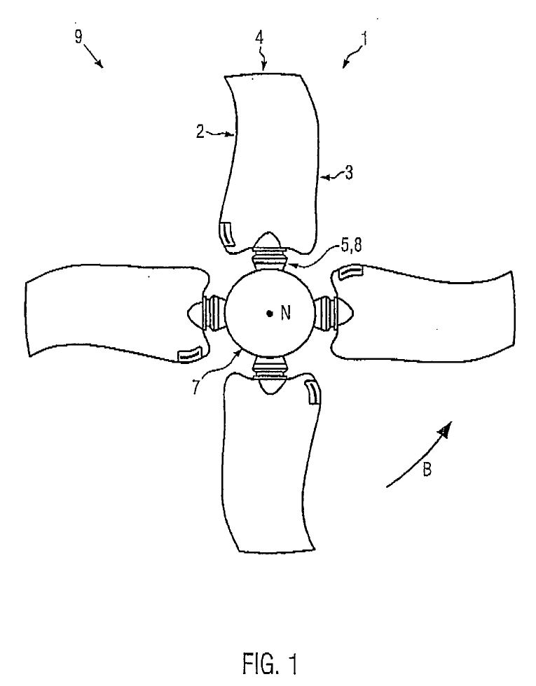

FIG. 1, a view of the pressure side of an embodiment of a ventilator in accordance with the invention;

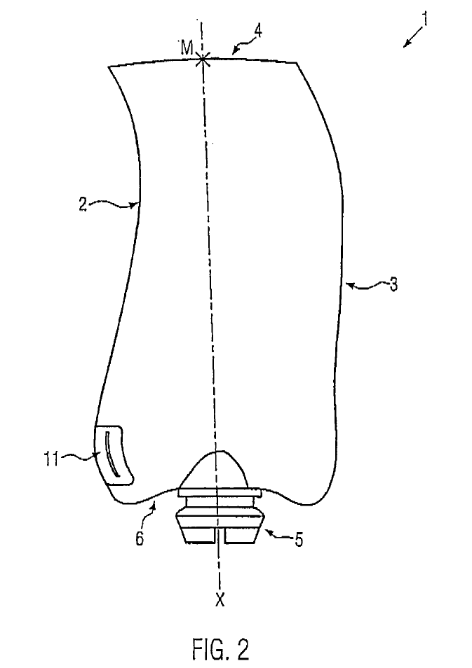

FIG. 2, a view of the pressure side of an embodiment of a ventilator blade in accordance with the invention;

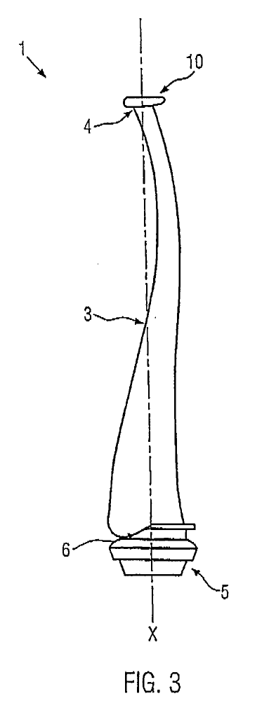

FIG. 3, a visible view of another embodiment of a ventilator blade, in accordance with the invention;

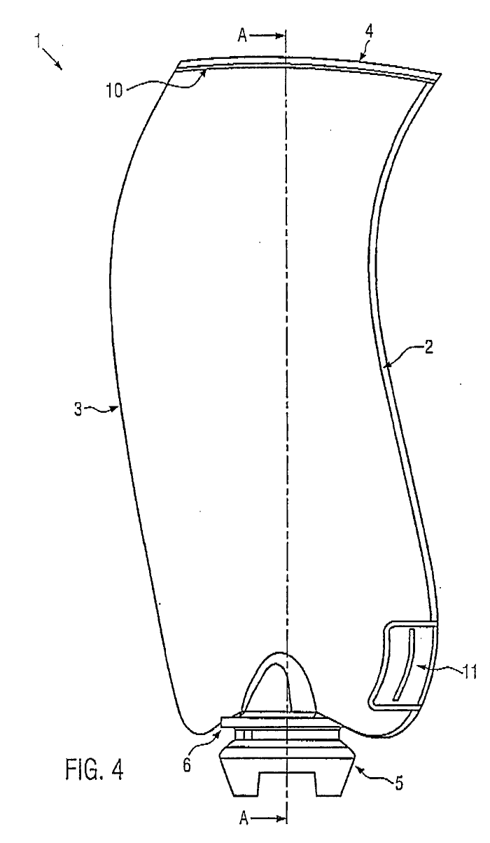

FIG. 4, a view of the suction side of another embodiment of a ventilator blade, in accordance with the invention;

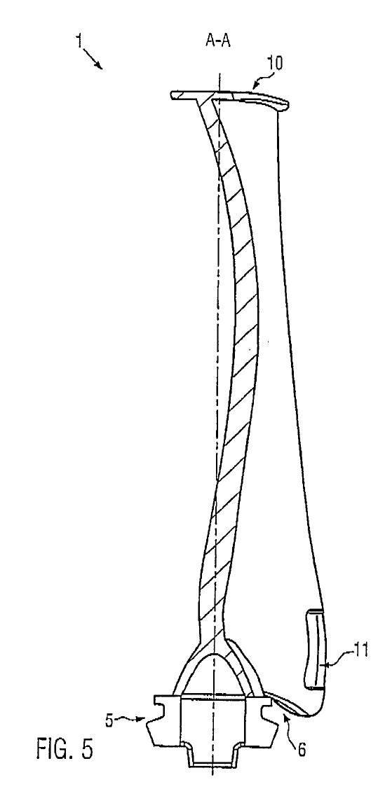

FIG. 5, a section of the ventilator blade from FIG. 4;

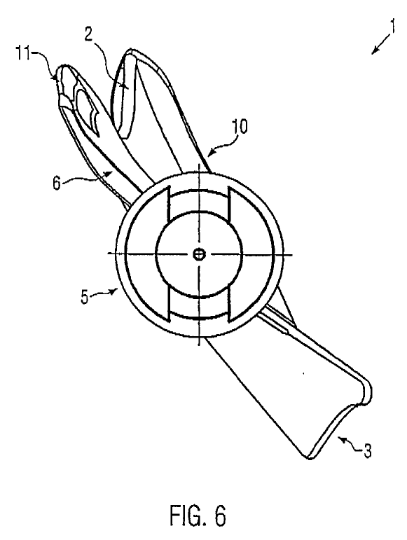

FIG. 6, a view of another embodiment of a ventilator blade in accordance with the invention, from the inside;

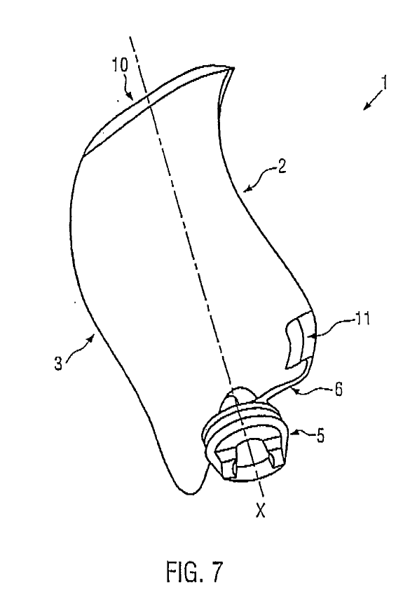

FIG. 7, a view of the suction side of another embodiment of a ventilator blade, in accordance with the invention;

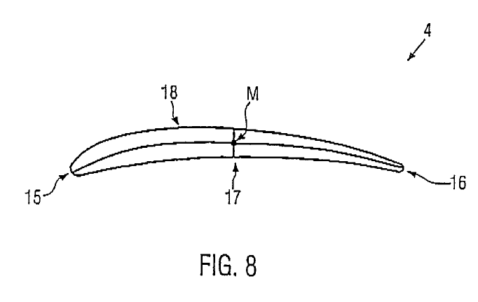

FIG. 8, an outside view of the outside edge of an embodiment of a ventilator blade, in accordance with the invention; and

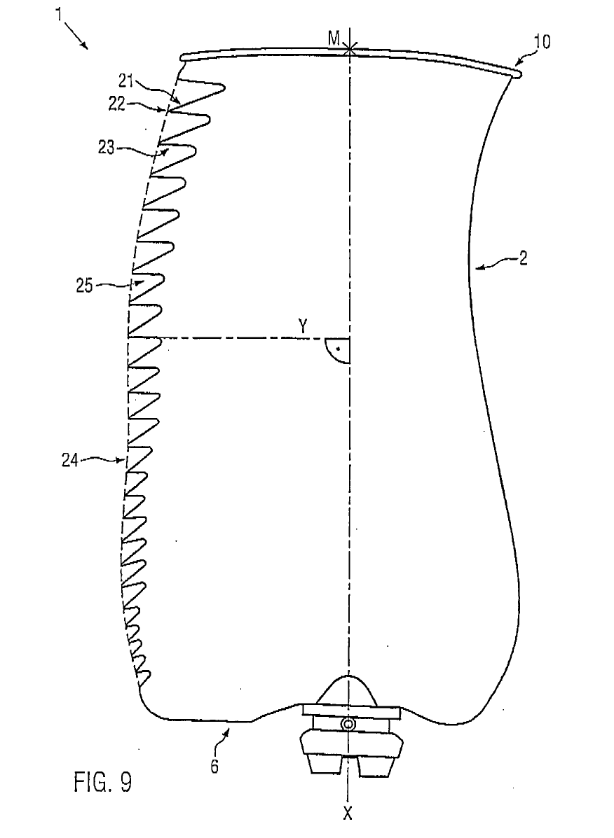

FIG. 9, a view of the suction side of another embodiment of a ventilator blade, in accordance with the invention.

FIG. 1 shows the pressure side of an embodiment of a ventilator 9. The ventilator 9 shows four ventilator blades 1, arranged in the form of a star around the hub 7, from which the pressure side can be seen in accordance with the direction of observation. For the fixing, fixing devices 8 placed on the hub hold the blade feet 5 of the ventilator blades 1. For example, the blade feet 5 are set into the fixing device 8 and then rotated around the radial ray, until they have attained the desired rotation position. The fixing in the selected position is attained, for example, by screws, clamping devices, such as springs, or by adjustable or adapted intermediate elements (which are not shown), used between the ventilator foot 5 and the fixing device 8. In the selection of the fixing mode, the (to some extent considerable) centrifugal forces, which act on the ventilator blades I when in operation have to be taken into consideration.

Not shown in the figure is the motor, which starts the ventilator 9 in a rotation movement about an axis protruding from the image plane through the center N of the hub 7. Arrow B indicates the normal direction of movement of the ventilator 9. For this direction of movement, in which the leading edges 1 move forward, the shape of the blades 1 is optimized. However, if needed, a movement in the other direction is also possible.

Instead of four blades 1, a ventilator 9 can comprise any even or odd number of ventilator blades 1, which are primarily placed at the same distance from one another.

The housing of the ventilator 9 is not shown in the figure. Typically, there is a gap, which, for example, measures 0.6% of the ventilator outside diameter between the inside wall of the housing and the outside edges 4 of the ventilator blades 1. With this width, the angle of incidence of the blades 1 of the ventilator shown 9 is adjustable by ca. 10° to 12°.

Different embodiments of ventilator blades 1 are shown in FIGS. 2-7.

FIG. 2 shows the pressure side of a true-to-scale embodiment of a ventilator blade 1. The leading edge 2, which leads when in operation, has a flat S-shape, wherein the reversal point, as seen from the inside, is not quite in the center of the leading edge 2. Also, the trailing edge 3 is curved. In the outer third, it runs parallel to the leading edge 3; in the two inner thirds, it exhibits small, barely pronounced curvatures with two reversal points. The corners of the inside edge 6 are somewhat pulled down in comparison to the other edge points, so that the inside edge 6 describes a curvature overall which opens downwardly, in the figure; it interrupts the blade foot 5 in the center.

The blade foot 5 is designed so as to join the ventilator blade 1 with the fixing device 8 placed on the hub 7 (see FIG. 1) and to adjust the desired angle of incidence.

The radial rays x of the individual blades I run outwardly from the center of the hub N of the ventilator 9, in the middle, through the blade foot 5 of the individual blade 1, in the form of a star. The center M of the outside edge 4 of the ventilator blade 1 falls on the radial ray x, as a rotation axis for the blade adjustment. The ends of the outside edge 4 thus move with a rotation about the rotation axis x [sic] on a circle with the distance of the end from the center M as a radius. As can be seen, the outside edge 4 also has a slight curvature, so that it is adapted to the shape of the (not shown) housing.

To clarify the ventilator blade design, length data of individual blade sections are given below, which refer to a specific embodiment. Depending on the volumetric displacement or other ventilator parameters, these length data can be accordingly scaled. Of course, the indicated length ratios should be understood to be non-limiting.

The length of the ventilator blade 1 shown in FIG. 2 is, for example, 13 cm without the blade foot 5. The overall width of the ventilator blade decreases outwardly, from the inside to the outside edge 4. The widest blade location is not found at the innermost point, but rather shifted outwards somewhat; it measures approximately 7 cm. At the narrowest location, the blade 1 has a width of ca. 5.5 cm. Thus, the ratio of the length of the ventilator blade 1 to its width varies in magnitude from 1.8 to 2.4. In other embodiments, the ratio of the blade length to the blade width is smaller than 1 for the entire blade or in certain places—for example, the outside edge 4 is then longer than the leading edge 2 and the trailing edge 3.

FIG. 3 is another embodiment of a ventilator blade in accordance with the invention, in a side view of the trailing edge 3; the suction side of the blade 1 is to the right in the figure.

From this perspective, the curvature of the blade 1 is clearly visible along the radial ray x: the suction side of the blade has a convex curvature; the opposite pressure side has a concave curvature. In comparison with the outside edge 4, the inside edge 6 is clearly curved away from the suctioned air.

The blade 1 shown also has a transverse piece (winglet) 10. It is set on the outside edge 4 and, on the suction and the pressure sides, juts out equally far beyond them. The angle between the transverse piece part protruding on the pressure side and the blade sheet is clearly more than 90° because of the blade curvature, whereas the angle between the transverse piece part protruding on the suction side and the blade sheet is clearly below it.

FIG. 4 shows the suction side of another embodiment of a ventilator blade 1 from a slightly later perspective. This blade 1 also has a transverse piece 10, which, as can be seen here, comes to an end with the length of the outside edge 4 and does not protrude over it. A slit 11 is also shown on the leading edge 2 in this figure, which is used, if necessary, as a holder for weights.

FIG. 5 presents a cross section along the A-A axis of the blade 1 of FIG. 4.

In this embodiment, the material thickness remains approximately constant over the greatest part of the blade length. Only in the outer third does it clearly decline, since lower forces act there than in the inner blade part. Preferably, the material thickness is not constant, in comparison to other sectional profiles, parallel to the shown cut.

The perspective of FIG. 6 shows a blade 1, as viewed from the hub toward the outside, which again clarifies the complex structure of the blade 1. Not only does the leading edge 2 exhibit an S-shape, but blade 1 is also curved from the inside outwards, in the direction of the radial ray x. Furthermore, the blade 1 also shows a curvature over its width, as can be seen on the inside edge 6. The end of the inside edge 6, which strikes the trailing edge 3, juts out somewhat in this embodiment.

The transverse piece 10 runs over the entire length of the outside edge 4, but ends with the trailing edge 2 and does not project beyond it. In order to create a favorable termination with regard to flow technology, the width of the transverse piece 10 recedes slowly up to the width of the leading edge. At the side of its projecting width, the transverse piece 10 multiplies the width of the outside edge, for example, by the factor of 3. In the embodiment shown, the transverse piece part projecting toward the suction side is designed wider that the transverse piece part projecting toward the pressure side.

In this embodiment, the blade foot 5 has a partially broken circular ring, on which, for example, a suitable (not shown) intermediate piece can be set. A fixing device 8 on the hub 7 in turn holds the intermediate piece and thus provides for a firm hold of the blade 1. The selection or adjustment of the intermediate piece specifies the angle of incidence of the blade 1.

FIG. 7 shows the suction side of another embodiment of a ventilator blade. Here, the curvature of the blade 1 is quite visible along the radial ray x, which is convex on the suction side as shown in the drawing. This embodiment also has a blade foot 5 and a transverse piece 10, described with reference to FIG. 6.

FIG. 8, a view from the outside in the direction of the radial ray, shows the outside edge 4 of an embodiment of a ventilator blade 1. From this perspective, the blade shape of the outside edge 4 can be seen. The trailing end 15 of the outside edge, where the leading edge intersects the outside edge, has a rounded-off shape, just like the opposite trailing edge 16. The radius of curvature of the rounding is clearly larger with the leading end 15 than with the trailing edge 16. On the long side edge 18, the suction side of the blade 1 and the outside edge 4 intersect; on the side edge 17, the pressure side and the outside edge 4 intersect. Due to the blade shape of the outside edge 4, the side edge 18 is longer than the side edge 17. As a result of the longer path along the side edge 18, when the ventilator is in operation air flowing along the side edge 18 must flow more rapidly than air flowing along the shorter side edge 17. In this way, a reduced pressure or suction is formed on the suction side of the blade 1, which suctions air from the surroundings of the ventilator 9, and pressure is formed on the pressure side, which distributes the air away from the ventilator 9.

Also drawn in is the center M of the outside edge 4, which is a point formed by the intersection of two lines, wherein the first line connects the leading end 15 with the trailing end 16 and the second line connects the center of the two long side edges 17 and 18.

Finally, FIG. 9 is an embodiment of a ventilator blade 1, whose trailing edge 3 is fringed. Two sections of the trailing edge 3 in the vicinity of the outside edge 4 and the inside edge 6 are not fringed, so that the outside and inside edges are not shortened, in comparison to the blade without a fringe shape. Overall, the trailing edge 3 has twenty-three tooth-shaped fringes 25 of various sizes, which comprise an inside edge 23, and outside edge 21, and a tip 22. From the inside to the outside, the innermost four, the following seven, the next six, and the six fringes which follow them form groups with fringes of the same size. The fringe size of a group increases from the innermost to the outermost group. For this embodiment, the size h of the individual fringes is determined in accordance with the formula

$$f ⪢ \frac{{w}_{∞}}{2 π h}$$

(see Thomas Carolus: Ventilators: Aerodynamic Draft, Acoustic Prediction, Construction). f is thereby a limit frequency, above which the noise reduction occurs. It can be specified by the operator (taking into consideration other design parameters). [blank] is the inflow rate, which is calculated individually in this embodiment for each fringe 25. It depends, among other things, on the distance of the fringe from the hub and the rotation speed of the ventilator.

Also, with regard to their shape, the fringes differ from the inside to the outside. Whereas the inside edges 23 of the inside and outside fringes 25 point slightly inwards, relative to the normal line y on the radial ray x, the inside edge 23 of the fringes 25 in the middle are at a right angle to the radial ray x, as the shown normal line y on the radial ray x makes clear. In this case, the inside edge 23 forms an angle of approximately 45° with the outside edge 21. This angle declines continuously with the fringes 25 further outside and inside.

All tips 22 lie on a conceived nonfringed trailing edge, which is shown by a broken line 24 in FIG. 9. As can be seen, the embodiment shown has material recesses, in comparison with a nonfringed blade. In accordance with the trailing edges 3, shown in the preceding figures, the nonfringed trailing edge 24 also has a shape which is favorable with respect to fluid mechanics.

1. Ventilator blade (1) with:
a leading edge (2), curved in the shape of an S in the blade sheet plane; and an outside edge (4), which is shorter than the leading edge; in which the center (M) of the outside edge (4) is in the vicinity of the rotation axis (x) of the ventilator blade (1).

2. Ventilator blade (1) according to claim 1, which has an at least partially fringed trailing edge (3).

3. Ventilator blade (1) according to claim 2, in which the size of each fringe (25) of the at least partially fringed trailing edge (3) depends on the inflow rate of a fluid which is approaching the individual fringe and/or a limit frequency which is to be specified, above which the reduction of noise is to be attained.

4. Ventilator blade (1) according to claim 3, in which each fringe (25) of the at least partially fringed trailing edge (3) has two edges (21,23), of which one is perpendicular to the rotation axis (x).

5. Ventilator blade (1) according to claim 1, whose trailing edge (3) is curved in the blade sheet plane.

6. Ventilator blade (1) according to claim 1, on whose outside edge (4), a transverse piece (10) is placed.

7. Ventilator blade (1) according to claim 6, in which the transverse piece (10) runs over the entire length of the outside edge (4) and protrudes over the entire length or a part of it, toward both sides, over the width of the outside edge (4).

8. Ventilator blade (1) according to claim 7, in which at the ends of the outside edge (4), the transverse piece has the width of the outside edge (4).

9. Ventilator blade (1) according to claim 1, whose blade sheet is curved along the rotation axis (x).

10. Ventilator blade (1) according to claim 1, whose section profile, parallel to the outside edge, has a blade shape at each point.

11. Ventilator blade (1) according to claim 1, which is curved over its width.

12. Ventilator blade (1) according to claim 1, in which the leading edge (2) and the trailing edge (3) run parallel to one another, in the outer area of the blade (1).

13. Ventilator blade (1) according to claim 1, in which the leading edge (2) and the trailing edge (3) have the smallest distance from one another, on their most extreme points.

14. Ventilator blade (1) according to claim 1, in which the trailing edge (3) has a total of three curvatures and two reversal points.

15. Ventilator (9), which comprises at least one ventilator blade (1), located around a driven hub (7), in accordance wit claim 1, wherein a rotation position of the at least one ventilator blade (1) around its rotation axis (x) can be adjusted.

16. Ventilator (9) according to claim 15, which is located in a housing, so that there is a narrow gap between the inside wall of the housing and the outside edge (4) of the at least one ventilator blade (1); this gap permits a parallel rotation of the at least one ventilator blade (1) around the rotation axis (x) at a prespecified angle.

17. Ventilator (9) according to claim 16, in which the outside edge (4) of the at least ventilator blade (1) has a curvature that is adapted to the curvature of the housing.
